(19) United States
(12) Patent Application Publication
(10) Pub. No.: US 2009/0017425 A1
(43) Pub. Date: Jan. 15, 2009

(54) Repositionable Color Chips

(75) Inventor: Donald Sylvester Woelfel, Ft. Wayne, IN (US)

Correspondence Address: MERCHANT & GOULD PC, P.O. BOX 2903, MINNEAPOLIS, MN, 55402-0903, US

(73) Assignee: COLWELL INDUSTRIES, INC., Minneapolis, MN (US)

(21) Appl. No.: 12/165,690

(22) Filed: Jul. 1, 2008

Related U.S. Application Data
(60) Provisional application No. 60/949,011, filed on Jul. 11, 2007.

(51) Int. Cl. G09F 5/04

(52) U.S. Cl. 434/98

(57) ABSTRACT

A color chip for mounting on a color card includes a chip substrate having a top surface and a bottom surface, a printed area including text disposed on the bottom surface of the chip substrate, and an adhesive coating on the bottom surface of the chip substrate. A color card assembly includes a color card having a front surface, a plurality of color chips mounted to the front surface of the color card, wherein each of the color chips includes a chip substrate having a top surface and a bottom surface. An adhesive coating is used to couple the bottom surface of each of the color chips to the color card, and an uncoated portion is disposed in an outer peripheral area between the bottom surface of each of the color chips and the color card, wherein the uncoated portion is not coated with the adhesive coating.

### TECHNICAL FIELD

The present disclosure relates to color card assemblies, and more particularly, to repositionable color chips.

### BACKGROUND

Repositionable color chips stored on a color card are a convenient way to determine what color or color scheme would look best on a surface. As multiple color chips can be removed from the card and placed on the surface, a preferred color for the surface can be found by comparing one of the color chips on the surface to other color chips on the surface. However, the ease with which the color chips can be removed from the color card presents difficulties. In addition, with many color chips removed from the color card, returning the color chips back to the appropriate location on the color card also presents difficulties.

### SUMMARY

An aspect of the present disclosure relates to a color chip for mounting on a color card including a chip substrate having a top surface and a bottom surface, a printed area including text disposed on the bottom surface of the chip substrate, and an adhesive coating on the bottom surface of the chip substrate.

Another aspect of the present disclosure relates to a color card assembly including a color card having a front surface, and a plurality of color chips mounted to the front surface of the color card, wherein each of the color chips includes a chip substrate having a top surface and a bottom surface. An adhesive coating is used to couple the bottom surface of each of the color chips to the color card, and an uncoated portion is disposed in an outer peripheral area between the bottom surface of each of the color chips and the color card, wherein the uncoated portion is not coated with the adhesive coating.

Yet another aspect of the present disclosure relates to a method of removing a color chip from a color card assembly, the method including: providing a color card assembly having a color card with a front surface and a plurality of color chips, wherein each of the color chips includes a chip substrate having a top surface and a bottom surface; mounting the color chips to the front surface of the color card using an adhesive so that an uncoated portion is disposed in an outer peripheral area between each of the color chips and the color card, wherein the adhesive does not coat the uncoated portion of the bottom surface; grasping the uncoated portion of one of the color chips; and pulling the uncoated portion of the color chip until the color chip is removed from the color card.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a front view of a color card assembly having features that are examples of aspects in accordance with the principles of the present disclosure.

FIG. 2 is a cross-sectional view of the color card assembly taken on line 2-2 of FIG. 1.

FIG. 3 is a back view of a color chip suitable for use with the color card assembly of FIG. 1.

FIG. 4 is a schematic representation of a process suitable to produce the color card assembly of FIG. 1.

FIG. 5 is a view of a pad plate having features that are examples of aspects in accordance with the principles of the present disclosure.

FIG. 6 is a schematic representation of another process suitable to produce the color card assembly of FIG. 1.

FIG. 7 is a view of a card blank having features that are examples of aspects in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

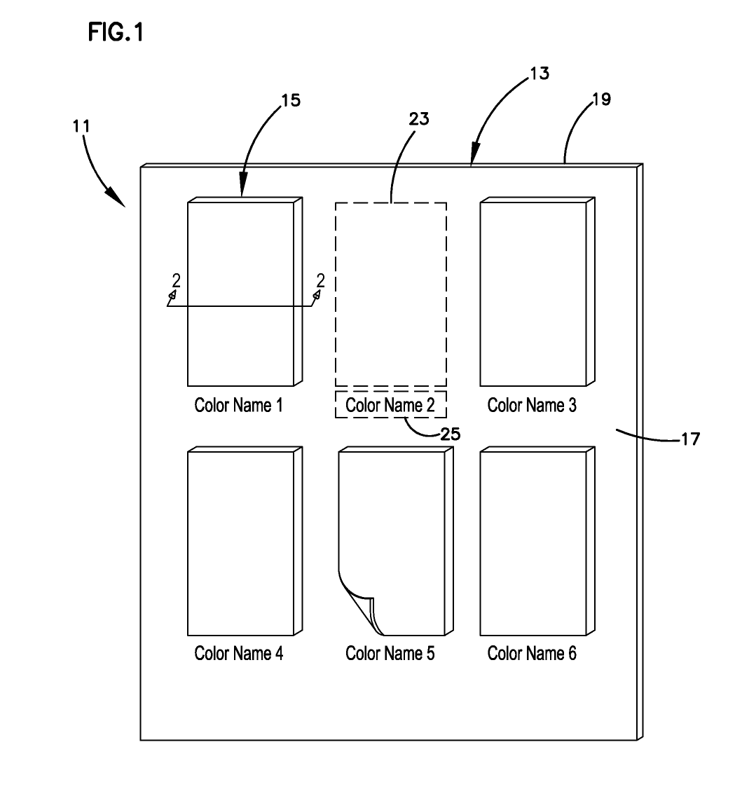

Referring now to FIG. 1, a color card assembly, generally designated 11 is illustrated. The color card assembly 11 includes a color card, generally designated 13, and a plurality of color chips, generally designated 15, that are removably affixed to the color card 13.

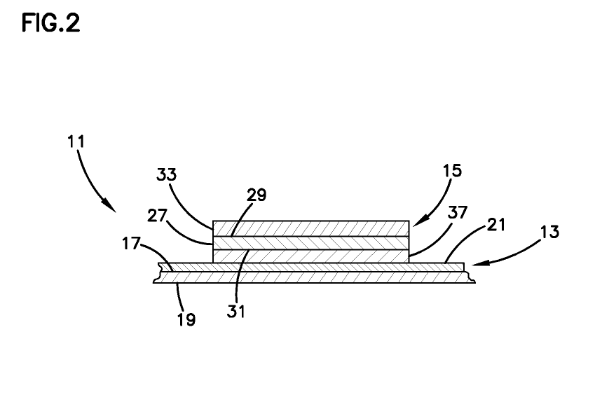

In the subject embodiment, the color card 13 is a paper material having a paper thickness of 8 to 10 mil. It will be understood, however, that the scope of the present disclosure is not limited to the color card 13 being a paper material having a paper thickness of 8 to 10 mil. The color card 13 includes a front surface 17 and a back surface 19. The front surface 17 is press varnished with a topcoat 21 (shown in FIG. 2). In the subject embodiment, the topcoat 21 is a clear UV cured topcoat 21 made of urethane and monomers. The topcoat 21 has a glossy finish that aids in the selective removability of the color chips 15 from the color card 13.

The front surface 17 of the color card 13 includes a plurality of mounting areas 23 (one of which is shown in FIG. 1 surrounded by dashed lines) for mounting the color chips 15 to the color card 13. In the subject embodiment, the mounting areas 23 are arranged in a plurality of rows and columns. It will be understood, however, that the scope of the present disclosure is not limited to the mounting areas 23 of the color card 13 being arranged in rows and columns.

The color card 13 further includes a plurality of text areas 25 (one of which is shown in FIG. 1 surrounded by dashed lines) disposed immediately adjacent to the mounting areas 23. While the text areas 25 in the subject embodiment are disposed below the mounting areas 23, it will be understood that the scope of the present disclosure is not limited to the text areas 25 being disposed below the mounting areas 23 as the text areas 25 could be disposed above the mounting areas 23 or on either side of the mounting areas 23. Each of the text areas 25 includes text that distinguishes the color chip 15 mounted in the mounting area 23 immediately adjacent to the text area 25 from other color chips 15 mounted on the color card 13. In one embodiment, the text in the text area 25 is a name corresponding to the color chip 15. In another embodiment, the text in the text area 25 is a product number corresponding to the color of the color chip 15. In yet another embodiment, the text in the text area 25 is a location number corresponding to the position of the color chip 15 on the color card 13. In the subject embodiment, the size of the text is in the range of 8 to 12 point.

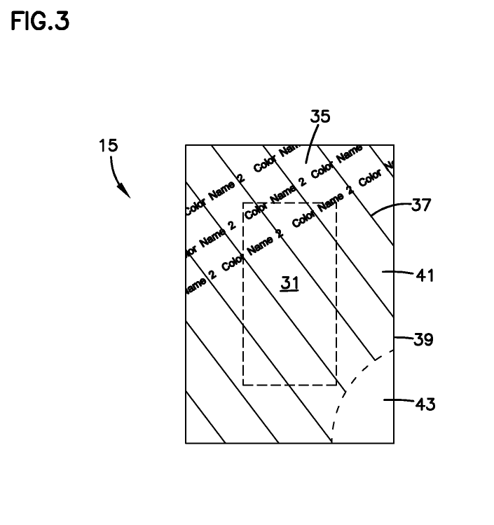

Referring now to FIGS. 2 and 3, the color chip 15 will be described. The color chip 15 includes a chip substrate 27 having a top surface 29 and a bottom surface 31. In the subject embodiment, the chip substrate 27 is a paper material having a weight designation of 100 lbs. It will be understood, however, that the scope of the present disclosure is not limited to the chip substrate 27 being a paper material having a weight designation of 100 lbs. The top surface 29 of the chip substrate 27 is coated with a color coating 33. In one embodiment, the color coating 33 is a paint coating, with the paint coating being either water-based or solvent-based and having either a flat, satin, semi-gloss or gloss finish. It will be understood, however, that the color coating 33 could also include other coatings such as a stain coating.

The bottom surface 31 of the chip substrate 27 includes a printed area 35 (shown in FIG. 3). In the subject embodiment, the printed area 35 includes text corresponding to the color coating 33 of the color chip 15. The text in the printed area 35 is similar to the text in the text area 25 on the color card 13, which corresponds to the mounting area 23 from which the color chip 15 was removed. In one embodiment, the text in the printed area 35 is a name corresponding to the color coating 33 of the color chip 15. In another embodiment, the text in the printed area 35 is a product number corresponding to the color coating 33 of the color chip 15. In yet another embodiment, the text in the printed area 35 is a location number corresponding to the position of the color chip 15 on the color card 13. In the subject embodiment, the size of the text in the printed area 35 is in the range of 8 to 12 point, although other font sizes can be used.

In the embodiment of FIG. 3, the text in the printed area 35 is repetitive. For example, the text in the printed area 35 in the embodiment of FIG. 3 includes the repetitive phrase “COLOR NUMBER 2”. While the scope of the present disclosure is not limited to the text in the printed area 35 repeating, the repetition of the text is preferred since it provides assurance that at least one of the repetitive phrases of the text in the printed area 35 will be readable following the manufacturing process, which will be described subsequently. In the subject embodiment, the text in the printed area 35 is shown in an angled orientation on the bottom surface 31 of the chip substrate 27. It will be understood, however, that the scope of the present disclosure is not limited to the text being in an angled orientation as the text could also be oriented horizontally or vertically on the bottom surface 31.

An adhesive coating 37 is applied to the bottom surface 31 of the chip substrate 27. The adhesive coating 37 bonds the color chip 15 to one of the mounting areas 23 on the coated front surface 17 of the color card 13. Since the adhesive coating 37 is applied to the bottom surface 31, the adhesive coating 37 is at least translucent so that the printed area 35 on the bottom surface 31 is still visible through the adhesive coating 37. In the subject embodiment, the adhesive coating 37 is a pressure-sensitive adhesive having low ultimate adhesion so that the color chip 15 can be selectively removed from the color card 13. In one embodiment, the pressure sensitive adhesive is an acrylic copolymer that is manufactured by Capital Adhesives and has a product number of R90920.

The bottom surface 31 also includes an outer peripheral edge 39 and an outer peripheral area 41 (shown in FIG. 3 as the area between the outer peripheral edge 39 of the color chip 15 and the dashed line). In one embodiment, a portion 43 of the outer peripheral area 41 of the bottom surface 31 is not coated with the adhesive coating 37 (shown as cross-hatching in FIG. 3). Having the portion 43 of the outer peripheral area 41 not coated with the adhesive coating 37 improves the removability of the color chip 15 from the color card 13, which will be discussed in greater detail subsequently.

As the portion 43 may be coated with other surface treatments, the term “uncoated portion” as used in the specification and the appended claims shall be understood to mean the portion 43 that is not coated with the adhesive coating 37 only. In one embodiment, and by way of example only, the percentage of the area of the uncoated portion 43 with respect to the bottom surface 31 is in the range of about 5% to 10%. In another embodiment, and by way of example only, the area of the uncoated portion 43 with respect to the bottom surface 31 is at least 5%. In a preferred embodiment, and by way of example only, the area of the uncoated portion 43 with respect to the bottom surface 31 is at least 10%. It will be understood, however, that the scope of the present disclosure is not limited to the area of the uncoated portion 43 being in the range of 5% to 10%, at least 5%, or at least 10% of the area of the bottom surface 31.

With the uncoated portion 43 of the color chip 15 not coated with the adhesive coating 37, the uncoated portion 43 provides a location at which to grasp the color chip 15 to selectively remove the color chip 15 from the color card 13. In a preferred embodiment, the uncoated portion 43 of the outer peripheral area 41 is disposed in a corner of the bottom surface 31. In an alternative embodiment, the uncoated portion 43 of the outer peripheral area 41 is disposed in multiple corners of the bottom surface 31. It will be understood, however, that the scope of the present disclosure is not limited to the uncoated portion 43 being in a corner of the bottom surface 31 or multiple corners of the bottom surface 31.

Referring now to FIGS. 1-3, the use of the color card assembly 11 will be described. In use, the color chips 15 mounted on the color card 13 can be removed from the color card 13 and placed on a surface, including but not limited to an architectural drawing, a designer layout, a color scheming plan, or directly onto a surface being considered for a color change. To remove the color chip 15 from the color card 13, the color chip 15 is peeled from the front surface 17 of the color card 13. In one embodiment, the color chip 15 is grasped at the uncoated portion 43 and pulled away from the front surface 17 of the color card 13 until the color chip 15 is no longer affixed to the color card 13. By providing a grasping location, the uncoated portion 43 facilitates peeling of the color chip 15 from the color card 13. With the color chip 15 peeled from the color card 13, the color chip 15 can be affixed to the desired surface by placing the bottom surface 31 of the color chip 15 against the surface and pressing the top surface of the color chip 15. Since the adhesive coating 37 remains on the bottom surface 31 of the color chip 15, the pressure applied to the color chip 15 affixes the color chip 15 to the surface.

To replace the color chip 15 on the front surface 17 of the color card 13, the color chip 15 is peeled from the surface. In one embodiment, the color chip 15 is grasped at the uncoated portion 43 and peeled away from the surface until the color chip 15 is no longer affixed to the surface. With the color chip 15 peeled from the surface, the color chip 15 is ready to be affixed to the color card 13. To determine the appropriate location on the color card 13 at which to mount the color chip 15, the text in the printed area 35 on the bottom surface 31 of the color chip 15 is compared to the text in the text areas 25 of the color card 13. The color chip 15 is mounted in the mounting area 23 immediately adjacent to the text area 25 having text that is similar to the text on the bottom surface 31 of the color chip 15. To mount the color chip 15 in the mounting area 23, the bottom surface 31 of the color chip is placed against the mounting area 23 on the front surface 17 of the color card 13. Pressure is then applied to the top surface of the color chip 15 until the color chip 15 is affixed.

By comparing the text in the printed areas 35 of the color chips 15 with the text in the text areas 25 of the color card 13, accurate replacement of multiple color chips 15 on the color card 13 is possible. In addition, by having the printed area 35 on the bottom surface 31 of the color chip 15 as opposed to the top surface of the color coating 33, the printed area 35 does not detract attention from the color coating 33 when the color chip 15 is affixed to the surface being considered for a color change.

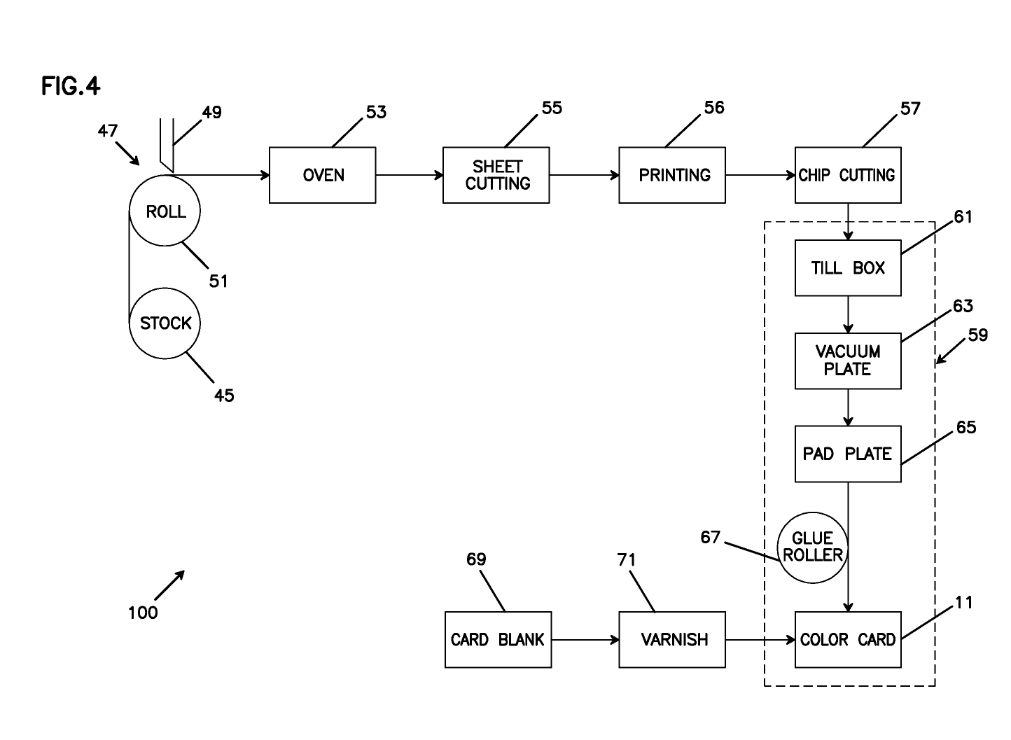

Referring now to FIG. 4, one example method 100 for manufacturing the color card assembly 11 will be described. A substrate stock 45 is drawn through a conventional knife-over-roll process, generally designated 47, to apply the color coating 33 to the top surface 29 of the substrate stock 45. In the knife-over-roll process 47, the color coating 33 is applied to the substrate stock 45 prior to the substrate stock 45 being passed between a knife 49 and a roll 51. The knife 49 and roll 51 remove excess coating such that the color coating 33 applied to the substrate stock 45 is uniform.

With the color coating 33 applied, the substrate stock 45 passes through a curing oven 53 having a temperature that is dependent on the composition of the color coating 33. After the color coating 33 has been cured, the substrate stock 45 is cut into substrate sheets using a rotary shear sheet cutting mechanism 55.

The substrate sheets are transferred to a printing operation 56. The printing operation applies the text to the printed area 35 on the bottom surface 31 of the substrate sheets. The text applied to the bottom surface 31 of the substrate sheet corresponds to the color coating 33 on the top surface 29. In the subject embodiment, the text is applied to the printed area 35 on the bottom surface of the substrate sheet by a lithographic press.

The substrate sheets are then transferred to a chip cutting mechanism 57 where the chip substrates 27 with the applied color coating 33 and text in the printed area 35 are cut from the substrate sheets using a die-cutting process or a guillotine-cutting process. As previously stated, the text in the printed area 35 of the bottom surface 31 of the chip substrate 27 is repetitive in a preferred embodiment. This repetition of the text in the printed area 25 assures that at least one of the repetitive phrases in the text is readable following the die-cutting or guillotine-cutting process.

The coated chip substrates 27 are then transferred to a mounting machine, generally designated 59, such as a modified Model C or Model D Jersey Mounting Machine. The mounting machine 59 includes a till box 61 that stores the coated chip substrates 27. Coated chip substrates 27 having the same color coating 33 are arranged in the till box 61 in a stacked orientation while coated chip substrates 27 having different color coatings 33 are arranged in the till box 61 in accordance with the design layout of the color card assembly 11. A vacuum plate 63 removes one coated chip substrate 27 of each color coating 33 from the bottom of the respective stack in the till box 61.

In the subject embodiment, the vacuum plate 63 is a flat plate with rubber vacuum nozzles that are spaced to remove one of each coated chip substrate 27 from the till box 61. A pad plate, which is generally designated 65 and will be described in greater detail subsequently, having a plurality of vacuum nozzles moves across the vacuum plate 63 and removes the coated chip substrates 27 with the vacuum nozzles from the vacuum plate 63. The pad plate 65 with the coated chip substrates 27 then moves across a glue roller 67, which is rotating in a pan of adhesive coating 37, such that the bottom surfaces 31 of the coated chip substrates 27 are coated with adhesive coating 37.

In a separate process, color card blanks 69 enter a press varnishing process 71 that applies the topcoat 21 to the front surface 17 of the color card blank 69. Following the press varnishing of the color card 13 and the application of the adhesive coating 37 to the coated chip substrate 27, the color chips 15 on the pad plate 65 are mounted to the color card 13 to form the color card assembly 11. In one embodiment, after the color chips 15 are mounted to the color card 13, the color card assembly 11 is folded by a folding operation.

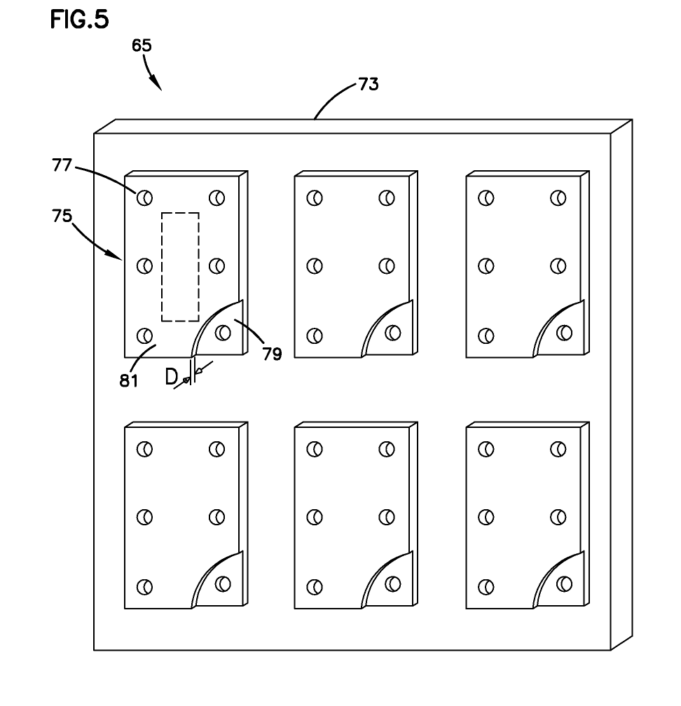

Referring now to FIG. 5, an exemplary embodiment of the pad plate 65 is shown. The pad plate 65 includes a base 73 with a plurality of pads, generally designated 75, mounted to the base. The pads 75 are adapted to receive the coated chip substrates 27 from the vacuum plate 63. In the subject embodiment, the pads 75 are made from a rubber material.

In the subject embodiment, each of the pads 75 defines a plurality of openings 77 through which the vacuum nozzles draw suction for removing the coated chip substrates 27 from the vacuum plate 63 and retaining the coated chip substrates 27 to the pad plate 65. Each of the pads 75 further includes a recessed portion 79 that is disposed in a peripheral area 81 of the pad 75, where the peripheral area 81 of the pad 75 corresponds to the outer peripheral area 41 of the color chip 15. The recessed portion 79 is indented a distance D from a top surface 83 of the pad 75. In a preferred embodiment, the distance D is in the range of 0.002 to 0.010 of an inch.

In use, the pad plate 65 removes the coated chip substrates 27 from the vacuum plate 63 with the suction drawn through the openings 77 in the pads 75 by the vacuum nozzles. The coated chip substrates 27 are oriented on the pads 75 such that the bottom surfaces 31 of the chip substrates 27 are exposed. In the subject embodiment, one of the openings 77 is disposed in the recessed portion 79. As suction is drawn through the opening 77 in the recessed portion 79, the area of the chip substrate 27 corresponding to the uncoated portion 43 is drawn into the recessed portion 79 of the pad 75. With the area of the chip substrate 27 corresponding to the uncoated portion 43 drawn into the recessed portion 79 of the pad 75, the adhesive coating 37 is not applied to this area of the chip substrate 27 as the pad plate 65 moves across the glue roller 67.

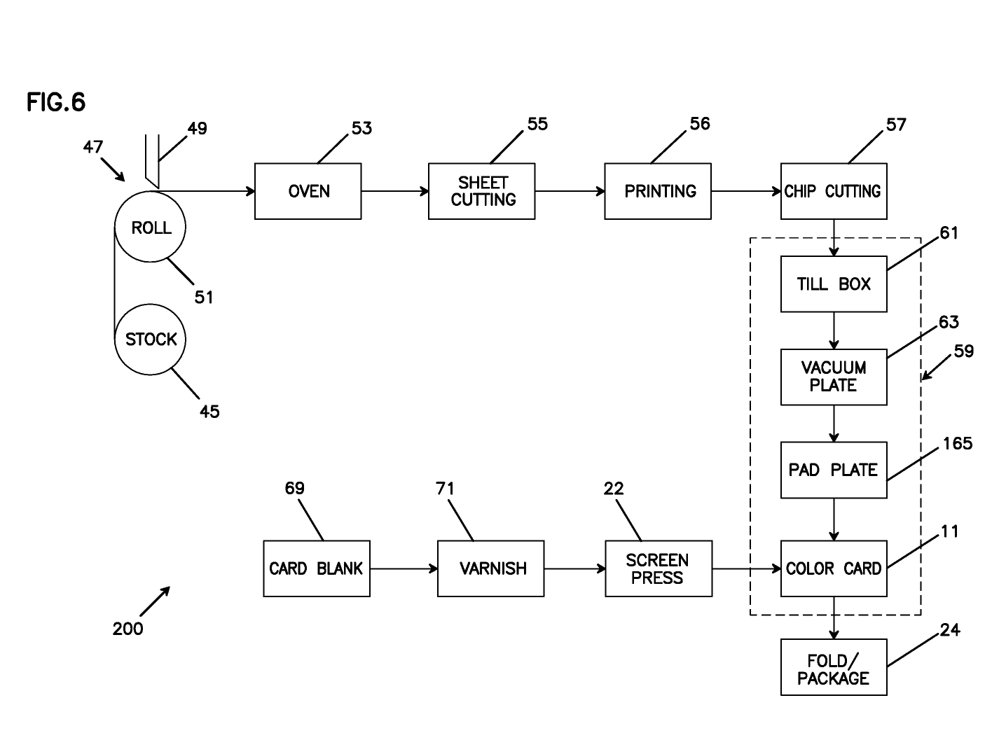

Referring now to FIG. 6, another example method 200 for manufacturing a color card assembly is described. The method 200 is similar to that of the method 100 described above, except for the differences noted below. Generally, the method 200 uses a screen press to add the adhesive to the card blank, rather than the glue roller of the method 100 that adds the adhesive to the color chips.

In method 200, the blank 69 is varnished at varnishing process 171. In the example shown, an in-line roll coater is used to apply the UV varnish to the blank 69. In one example, the blank 69 is coated with varnish on both sides. In another example, only one side of the blank 69 is coated.

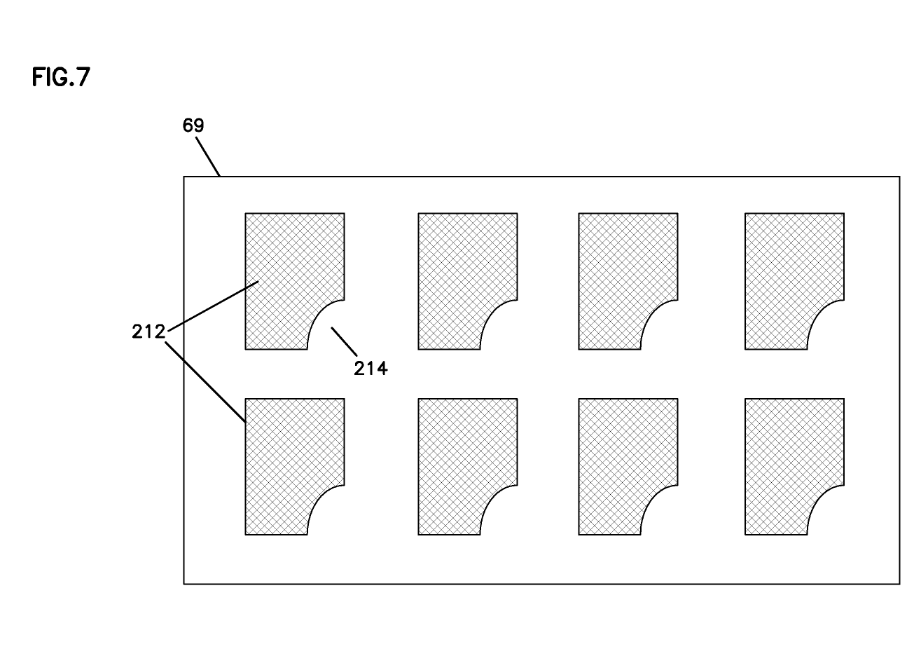

Next, a cylinder screen press 22 is used to apply glue to the blank 69 (rather than to the color chip as done in the method 100 above). As shown in FIG. 7, the glue 212 is applied to a plurality of locations on the blank 69, each corresponding to a location of the placement a color chip 15. A portion 214 is not printed with the glue 212 so that when the color chips 15 are positioned on the blank 69, the portion of the color chips 15 positioned over the portion 214 do not stick to the blank 69, thereby allowing the color chips 15 to be readily removed from the blank 69. In one example, a General screen press manufactured by BecMar of Bailey, Mich. is used to apply the glue 212 to the blank 69.

Referring again to FIG. 6, a pad plate 165 delivers the color chips 15 onto the glue 212 on the blank 69. The pad plate 165 can be similar to that of pad plate 65 described above, except that the pad plate 165 need not include the recessed portions 79. After the color chips 15 are positioned on the blank 69 to form the color card 11, the color card 11 can be folded and packaged at the folding process 24, if desired.

Part of the glue that is applied to the blank 69 is transferred to the color chips 15 when the color chips 15 are added to the blank 69. In this manner, when one of the color chips 15 is removed, the color chip 15 retains some of the glue so that the color chip 15 can be temporarily affixed to another surface, as described above.

In yet another alternative embodiment, an atomizer can be used to apply the glue to the blank or the color cards. An example of such an atomizer is a Vansco 82 Series atomizer manufactured by Vansco of South El Monte, Calif. For example, in one embodiment, an atomizer can be used to spray the glue in the desired pattern

1. A color chip for mounting on a color card comprising:
a chip substrate having a top surface and a bottom surface;
a printed area including text disposed on the bottom surface of the chip substrate; and
an adhesive coating on the bottom surface of the chip substrate.

2. A color chip for mounting on a color card as claimed in claim 1, wherein the text in the printed area on the bottom surface of the chip substrate is repetitive.

3. A color chip for mounting on a color card as claimed in claim 1, further comprising a color coating applied to the top surface of the chip substrate.

4. A color chip for mounting on a color card as claimed in claim 3, wherein the text in the printed area designates the color coating.

5. A color chip for mounting on a color card as claimed in claim 4, wherein the text in the printed area includes a name of the color coating.

6. A color chip for mounting on a color card as claimed in claim 1, wherein the text in the printed area is visible through the adhesive coating.

7. A color chip for mounting on a color card as claimed in claim 1, further comprising an uncoated portion disposed in an outer peripheral area of the bottom surface, wherein the uncoated portion is not coated with the adhesive coating.

8. A color chip for mounting on a color card as claimed in claim 7, wherein the area of the uncoated portion is in the range of 5% to 10% of the area of the bottom surface of the chip substrate.

9. A color chip for mounting on a color card as claimed in claim 7, wherein the uncoated portion is disposed in a corner of the outer peripheral area.

10. A color card assembly comprising:
a color card having a front surface; and
a plurality of color chips mounted to the front surface of the color card, wherein each of the color chips includes a chip substrate having a top surface and a bottom surface;
wherein an adhesive coating is used to couple the bottom surface of each of the color chips to the color card; and
wherein an uncoated portion is disposed in an outer peripheral area between the bottom surface of each of the color chips and the color card, wherein the uncoated portion is not coated with the adhesive coating.

11. The color card assembly as claimed in claim 10, wherein the adhesive is initially applied to the color chips.

12. The color card assembly as claimed in claim 10, wherein the adhesive is initially applied to the front surface of the color card.

13. A color card assembly as claimed in claim 10, wherein the uncoated portion is disposed in a corner of the outer peripheral area.

14. A color card assembly as claimed in claim 10, further comprising a printed area including text disposed on the bottom surface of each of the color cards, wherein the text in the printed area designates the color coating.

15. A method of removing a color chip from a color card assembly, the method comprising:
providing a color card assembly having a color card with a front surface and a plurality of color chips, wherein each of the color chips includes a chip substrate having a top surface and a bottom surface;
mounting the color chips to the front surface of the color card using an adhesive so that an uncoated portion is disposed in an outer peripheral area between each of the color chips and the color card, wherein the adhesive does not coat the uncoated portion of the bottom surface;
grasping the uncoated portion of one of the color chips; and
pulling the uncoated portion of the color chip until the color chip is removed from the color card.

16. A method of removing a color chip from a color card assembly as claimed in claim 15, further comprising initially applying the adhesive to the front surface of the color card.

17. A method of removing a color chip from a color card assembly as claimed in claim 15, further comprising initially applying the adhesive to the bottom surface of the chip substrate of each of the color chips.

18. A method of removing a color chip from a color card assembly as claimed in claim 15, wherein the uncoated portion is disposed in a corner of the outer peripheral area.

19. A method of removing a color chip from a color card assembly as claimed in claim 15, wherein the bottom surface includes text in a printed area.

20. A method of removing a color chip from a color card assembly as claimed in claim 19, further comprising:
comparing the text in the printed area on the bottom surface of the chip substrate to text in text areas of the color card; and
mounting the color chip in the mounting area of the color card immediately adjacent to the text area having text that is most similar to the text in the printed area on the bottom surface.
